(19) United States
(12) Patent Application Publication
(10) Pub. No.: US 2009/0147403 A1
(43) Pub. Date: Jun. 11, 2009

(54) Perpendicular magnetic recording medium and magnetic recording system

(76) Inventors: Ryoko Araki, Tokyo (JP); Yoshio Takahashi, Osaka (JP)

Correspondence Address: TOWNSEND AND TOWNSEND AND CREW LLP, TWO EMBARCADERO CENTER, 8TH FLOOR, SAN FRANCISCO, CA, 94111, US

(21) Appl. No.: 12/313,292

(22) Filed: Nov. 18, 2008

(30) Foreign Application Priority Data
Dec. 6, 2007 (JP) 2007-315435

(51) Int. Cl. G11B 5/82; G11B 5/62

(52) U.S. Cl. 360/135; 428/800; G9B/5.293

(57) ABSTRACT

Embodiments in accordance with the present invention provide a perpendicular magnetic recording medium where the signal to noise (S/N) of the media is improved. In a particular embodiment, a magnetic layer is applied to the recording magnetic layer of the recording medium in which the normalization crystal grain cluster size (Dn) is controlled so as to satisfy 1≦Dn≦1.9, where the mean value of the recording crystal grain cluster area obtained by summation of the area of neighboring grains having the same crystal orientation in both the a-axis and the c-axis of the recording layer crystal grain of the magnetic layer is normalized by the mean grain size.

### CROSS-REFERENCE TO RELATED APPLICATION

The instant nonprovisional patent application claims priority to Japanese Patent Application No. 2007-315435, filed Dec. 6, 2007 and which is incorporated by reference in its entirety herein for all purposes.

### BACKGROUND OF THE INVENTION

Many of the recording modes used in current hard disk drives (HDDs) are longitudinal recording, where recording is performed by directing the magnetization in the in-plane direction on the media. In order to achieve a downsizing and an increase in the capacity of hard disk drives and to achieve a hard disk device having a higher recording density, a perpendicular magnetic recording method has been actively discussed where the magnetization is directed in a direction perpendicular to the substrate. The recording medium used for a perpendicular magnetic recording has an easy axis in a direction nearly perpendicular to the substrate, and includes a magnetic recording layer to maintain the record and a soft magnetic under layer to utilize the magnetic field of the magnetic head efficiently.

Since the magnetization becomes directed antiparallel to each other at the boundary (magnetization transition region) of the recorded magnetization domain (recording bit) in the perpendicular recording method, it is magnetically stabilized compared with the longitudinal recording and, since the demagnetizing field is small in the magnetization transition region, the media noise is decreased. As grains for the recording layer in order to achieve this recording, an alloy containing a CoCrPt system and a CoCrTa system which have been used for longitudinal recording is used, and a Cr system oxide is precipitated around the magnetic recording layer grains to make grain boundaries, thereby yielding a solution to decrease the media noise. However, even if a CoCrPt system and CoCrTa system alloy, which have been used for the longitudinal recording, are used for the perpendicular recording layer, it has been difficult to decrease the media noise because the segregation of Cr is small. Therefore, perpendicular magnetic recording media has been proposed where an oxide and a nitride are added thereto and grain boundaries are formed around the magnetic layer grains and partitioning them from each other.

As a measure for decreasing the media noise with regard to the microstructure of media, it is provided that the grain size of the magnetic crystal grains are made finer or uniform and the exchange interaction between neighboring crystal grains are made smaller. Since the unit of the magnetization switching is one crystal grain included in the magnetic recording layer or one where a plurality of them are combined, the width of the magnetization transition region strongly depends on the size of the magnetization switching unit.

In order to decrease the media noise by decreasing the crystal grain size of the recording layer used for the perpendicular magnetic recording media, Japanese Unexamined Patent Application Publication No. 2006-331582 discloses a technique where an element selected from Cu, Ag, and Au is deposited over the metallic seed layer on the substrate to decrease the magnetic recording grain size. Moreover, Japanese Unexamined Patent Application Publication No. 2005-216362 discloses a technique where the shape of the recording layer magnetic grains is made a multilayer and like a truncated cone in which the grain size in the final stage of deposition is made smaller than the grain size in the initial stage of deposition, resulting in the grain size bring decreased.

On the other hand, in order to decrease the interaction between the crystal grains, perpendicular magnetic recording media having a granular structure is proposed where the surroundings (grain boundary) of the magnetic crystal grains are surrounded by the nonmagnetic material. For instance, a granular structured perpendicular magnetic recording media is disclosed in Japanese Unexamined Patent Application Publication No. 2002-358615 where the average gap between the grains is made 1.0 nm or more. As a grain boundary layer used therein, an oxide, a nitride, a fluoride, and a carbide are illustrated. Moreover, in Japanese Unexamined Patent Application Publication No. 2005-190517, a technology is disclosed where a Cu layer is sputtered underneath of the Ru intermediate layer and the magnetic recording grains are isolated.

### BRIEF SUMMARY OF THE INVENTION

Embodiments in accordance with the present invention provide a perpendicular magnetic recording medium where the signal to noise (S/N) of the media is improved. In a particular embodiment, a magnetic layer is applied to the recording magnetic layer of the recording medium in which the normalization crystal grain cluster size (Dn) is controlled so as to satisfy 1≦Dn≦1.9, where the mean value of the recording crystal grain cluster area obtained by summation of the area of neighboring grains having the same crystal orientation in both the a-axis and the c-axis of the recording layer crystal grain of the magnetic layer is normalized by the mean grain size.

### BRIEF DESCRIPTION OF THE DRAWINGS

FIG. 1 is a cross-sectional drawing illustrating a relationship between crystal grains and grain boundaries of a seed layer, an intermediate layer, and a magnetic recording layer.

FIG. 2 is a cross-sectional drawing illustrating a relationship between crystal grains and grain boundaries of a seed layer, an intermediate layer, and a magnetic recording layer.

FIG. 3 is a drawing illustrating an example of the layer configuration of perpendicular magnetic recording media.

FIG. 4 is a drawing illustrating a method for measuring the mean grain size.

FIG. 5 is a crystal lattice image of perpendicular magnetic recording media observed from the disk plane direction by using a transmission electron microscope.

FIG. 6 is a drawing illustrating a crystal lattice of grains (a) comprising a cluster, and grains (b) which do not comprise a cluster.

FIG. 7 is a diagram which shows the relationship between the value of the media S/N and the normalization crystal grain cluster size.

FIG. 8 is a diagram which shows the relationship between the value of bit error rate (BitER) and the normalization crystal grain cluster size.

FIG. 9 is a cross-sectional schematic drawing illustrating a magnetic recording system.

### DETAILED DESCRIPTION OF THE INVENTION

Embodiments of the present invention relate to perpendicular magnetic recording media and a magnetic recording system, and, specifically, relate to a perpendicular magnetic recording medium having a magnetic recording layer which includes nearly columnar structured magnetic crystal grains and the grain boundaries, and a magnetic recording system where the medium is installed.

In order to achieve a high areal density in perpendicular magnetic recording media, it is necessary to decrease the media noise and improve the media S/N. Therefore, it is necessary to decrease the magnetic recording grains and pursue the isolation of the magnetic grains. It is understood that decreasing the grain size of the recording magnetic layer is made possible by controlling the gas pressure and the substrate temperature during deposition of the recording magnetic layer and by putting an additive to the recording magnetic layer, and that isolation of the magnetic recording grains is made possible by increasing the ratio of additives of the nonmagnetic material which forms the nonmagnetic grain boundaries.

However, the crystalline orientation of the grains cannot be controlled only by decreasing the magnetic recording grain size and increasing the ratio of additives of the nonmagnetic material, and phenomena were observed where the controllability for uniform isolation between the magnetic recording grains, that is, intergranular interaction is low.

Then, according to a detailed study of the crystal structure in the magnetic layer grains using lattice which was done using a transmission electron microscope, it became clear that the region where a-axis orientation had the same direction as some of the neighboring grains and the region where the neighboring grains were oriented in a different direction, were mixed. Moreover, as a result of measurements of the grain boundary width, it was understood that the grain boundary width formed between the neighboring grains having the same crystal orientation was smaller than the grain boundary width formed between neighboring grains having different crystal orientations. Accordingly, the region where the crystal orientation is aligned, that is, the region where the crystal grain clusters are formed becomes a region where the intergrain interaction cannot be decreased, so that perpendicular magnetic recording media having such a microstructure does not have a sufficiently low intergrain interaction, and it is difficult to obtain perpendicular magnetic recording media having high media S/N and excellent BitER (bit error rate).

It is an objective of embodiments of the present invention to provide a perpendicular magnetic recording media where the crystal orientation of the recording layer grains is controlled and which has a granular structure where the isolation of grains is promoted and perpendicular magnetic recording media where the magnetic recording characteristics are improved.

The objective of embodiments of the present invention can be achieved by forming perpendicular magnetic recording media having a granular structure where the crystal orientation of neighboring magnetic layer grains is appropriately controlled not to be aligned in one direction. Specifically, the area obtained by summation of the neighboring particle areas which have the same crystal orientation in both the a-axis and the c-axis of the crystal grain in the recording magnetic layer is averaged in the recording layer and the obtained value is defined as a crystal grain cluster, and a value, where the mean area is divided by the mean area of the magnetic crystal grains, (it is defined as a normalization crystal grain cluster size) is taken as an index of alignment of the crystal orientation of the magnetic crystal grains.

A medium of an embodiment of the present invention has a normalization crystal grain cluster size Dn of 1≦Dn≦1.9, and can be 1≦Dn≦1.7 in order to control it more appropriately. The crystal grain cluster is the area behaving in a magnetically similar way during recording. It indicates the area where the crystal orientations of the neighboring magnetic grains have the same direction.

According to embodiments of the present invention, perpendicular magnetic recording media can be provided, where the exchange coupling between the magnetic crystal grains is suppressed, by controlling the crystal orientation of the seed layer grains and the crystal grain orientation of the magnetic recording layer grains in an appropriate relation and suppressing the formation of crystal grain clusters. Therefore, since the media noise can be decreased, perpendicular magnetic recording media having a high S/N can be provided.

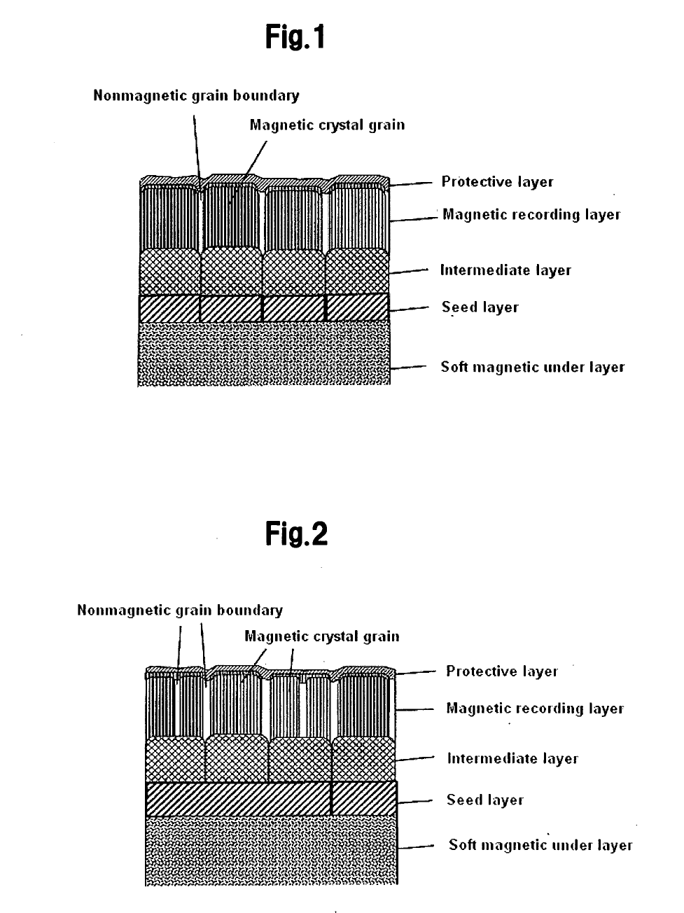

Based on the knowledge acquired by research, the relationship between the recording magnetic layer crystal grains, the nonmagnetic intermediate layer, and the seed layer will be described referring to FIG. 1 and FIG. 2. Since epitaxial growth is achieved between the recording magnetic layer grains and the nonmagnetic intermediate layer and between the nonmagnetic intermediate layer and the seed layer, the crystalline orientation thereof is always controlled by the deposition conditions and the crystalline orientation of the layer formed immediately below it. As shown in FIG. 1, when the grain size and the crystalline orientation of the seed layer are controlled by various techniques, the seed layer grains correspond one by one to the nonmagnetic intermediate layer grains formed thereon and they are deposited controlling the crystalline orientation. Therefore, when the recording magnetic layer grains are deposited, they are formed controlling the grain size and the crystalline orientation. Moreover, even if only the recording magnetic layer grains are controlled to have a smaller grain size and if the grains of the nonmagnetic intermediate layer are not controlled as shown in FIG. 1, the crystal orientation of the magnetic recording grains formed over the same nonmagnetic intermediate layer become the same as each other. Furthermore, for the grains shown in the left side of FIG. 2, when the nonmagnetic intermediate grains are formed over the same seed layer, the crystal orientation of the nonmagnetic intermediate layer grains becomes the same, so that the crystal orientation of the recording magnetic layer grains formed thereon becomes the same. Therefore, it has been discovered that an area defined as a crystal grain cluster is formed, where the crystal orientation is aligned, not only in the magnetic recording grains, which are formed multiply over the same nonmagnetic intermediate layer grains, but also in the magnetic recording grains formed over other intermediate layer grains, thereby the grain boundary width formed surrounding them becomes very narrow. Specifically, in order not to form a crystal grain cluster, the crystal orientations of the magnetic recording grains are individually aligned in different directions while decreasing the magnetic recording grain size. Moreover, it has been discovered that formation of a crystal grain cluster like this causes a decrease in the media S/N and a deterioration of the BitER. Embodiments of the present invention are accomplished based on such knowledge.

Hereafter, embodiments of the present invention will be described more in detail referring to the drawings.

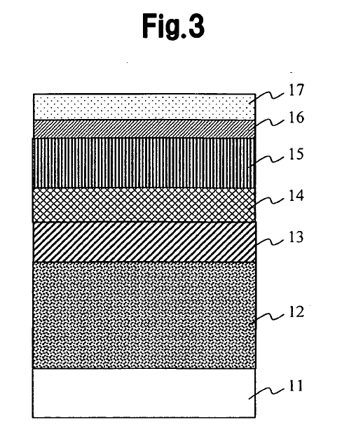

FIG. 3 is a structural example of perpendicular magnetic recording media according to one embodiment of the present invention. Over a disk substrate 11, a soft magnetic under layer 12, a seed layer 13, a nonmagnetic intermediate layer 14, a magnetic recording layer 15 having perpendicular magnetic anisotropy, a protective layer 16, and a lubricant layer 17 are formed. These layers are formed over both surfaces of the disk substrate. In the aforementioned layers, the soft magnetic under layer 12, the seed layer 13, the intermediate layer 14, and the magnetic recording layer 15 can be formed by using, for instance, a magnetron sputtered system. The protective layer 16 can be formed by using ion beam deposition and CVD, and the lubricant layer 17 is formed by using dipping. Moreover, each layer may be formed by using other techniques such as vacuum deposition, an ECR sputter method, CVD, and a spin coat method.

Various substrates having a flat surface, such as a NiP plated Al system alloy substrate, a tempered glass substrate, a crystallized glass substrate, and a ceramic substrate can be used for the substrate. Additionally, if it is a substrate formed of a material which is nonmagnetic, has an excellent flat surface, and is not magnetized and deformed by heating up to around 300° C., it also can be used in the same way. As for the surface of the substrate, polishing may be performed to make it have an average roughness of 3 nm or less and minute grooves which are called texture may be formed in the disk circumferential direction.

A material with small coercivity having soft magnetic properties is used for the soft magnetic under layer and an alloy such as, for instance, CoTaZr, CoFeB, FeTaC, FeAlSi, FeCoN, and NiFe, etc. can be used. Additionally, a material which has soft magnetic properties and a saturation flux density of 1 T or more can be similarly used. Moreover, the soft magnetic under layer may be provided with a magnetic domain control layer in order to align the magnetization direction in the disk radial direction. The magnetization direction of the soft magnetic under layer can be pinned by inserting an antiferromagnetic material such as FeMn, IrMn, MnPt, and CrMnPt, etc. in the bottom part, the middle part, and the top part, etc. of the soft magnetic under layer and heating and cooling it under the condition where a magnetic field is applied in the disk radial direction, and the soft magnetic under layer is made a multilayer by sandwiching a plurality of about 1 nm thick nonmagnetic materials, resulting in each layer being coupled antiferromagnetically, the magnetization direction being pinned, and the reproducing noise being controlled. The soft magnetic under layer plays a part of the role of the magnetic head where the magnetic field, mainly from the magnetic head, is passed and returned to the magnetic head. Therefore, it may have a thickness for passing magnetic flux from the magnetic head without making it magnetically saturated, and the thickness of the soft magnetic head is preferably in the range from 20 to 200 nm. A nonmagnetic material such as Cr, NiTa, NiTaZr, CrTi, CrTiTa, and TiAl, etc. may be inserted between the soft magnetic under layer and the substrate in order to improve the adhesion between the soft magnetic under layer and the substrate and to control the chemical reaction between the substrate and the soft magnetic under layer and the diffusion of elements. Additionally, if it is a nonmagnetic material which achieves the aforementioned purpose, it may be used in same way. Moreover, if the magnetic flux from the write head can be maintained, it is possible to omit the soft magnetic under layer.

The seed layer plays the role of controlling the crystalline orientation and crystal grain size of the intermediate layer and the recording layer formed thereon and the role of preventing the mixing of the soft magnetic under layer and the intermediate layer. The film thickness, structure, and material of the seed layer which control the crystalline orientation and the crystal grain size can be set in a range to obtain the aforementioned effects. Moreover, the seed layer may include plural layers. For instance, an oxide layer such as MgO, etc., a metallic layer such as Ta, Ni, and Ti, etc. or an alloy such as NiTa, CrTi, and NiCr, etc. is formed to be 2 to 10 nm as a first seed layer. Thereon, as the second seed layer, Pd etc. is deposited to be a very thin film thickness of 2 nm or less which becomes a nucleus of grain growth for controlling the crystal grain size of the intermediate layer and the crystalline orientation dispersed among neighboring grains, and it may be an island shaped layer. At this time, alignment may be controlled by heating the substrate. Moreover, instead of forming the second seed layer, the same effects can be obtained by heating the surface of the first seed layer, and it can be used as a substitute for the second seed layer.

Furthermore, as a third seed layer, a Ni system alloy having an fcc structure and one where an oxide or a nitride of Si, Ti, Al, and Ta, etc. are added to a Ti system alloy having an hcp structure are deposited to be 1 to 6 nm, resulting in forming a layer which has the role of matching the lattice constant of the intermediate layer and the lattice constant of the seed layer. Deterioration of the crystalline orientation is controlled by this film thickness and the crystal grain size can also be controlled. If an intermediate layer such as Ru, etc. is formed thereon, the grains grow using the island shaped layer formed above as a nucleus, so that a polycrystalline layer having a [001] aligned hcp structure can be formed. When it is deposited, a negative bias voltage from −150 V to −300 V is applied. The crystal grain size and the crystalline orientation can be easily controlled by controlling the substrate temperature while depositing the seed layer, the sputtering gas pressure, the oxygen added to the sputtering gas, the deposition rate, the film thickness, and the density of the island-shaped nucleus. The total film thickness of the seed layer is preferably 2 nm or more and 15 nm or less. When it is thinner than 2 nm, the crystallinity and the crystalline orientation of the intermediate layer becomes insufficient and the crystallinity of the magnetic recording layer is decreased, resulting in the isolation of the soft magnetic under layer being inadequate. Moreover, when it is thicker than 15 nm, the distance between the magnetic head and the soft magnetic under layer becomes too large, so that a deterioration of the overwrite property due to the strong magnetic head field not being able to be applied to the magnetic recording layer and a deterioration of thermal stability of the recording magnetization due to the medium coercivity not being able to be made higher are introduced.

The intermediate layer includes a nonmagnetic material including crystal grains which have a nearly columnar structure. It is used for controlling the crystalline orientation of the material used for the magnetic recording layer and preferably has an hcp structure or an fcc structure, and the preferred orientation direction thereof is [001]. A material used for it is, for instance, Ru and an alloy thereof, CoCr and an alloy thereof, Ti and an alloy thereof, and Rh and an alloy thereof, and an element to make it an alloy is selected from Ru, Cr, B, V, Zr, Mo, and W, etc. The lattice constant is changed by making it an alloy and lattice matching with the magnetic recording layer formed thereon can be made better. Moreover, the intermediate layer is made a multilayer and the roughness is made on the surface of the intermediate layer by adding an alloy oxide during Ru surface deposition and performing a surface oxidation treatment, so that it is possible to promote the isolation of the magnetic layer of the recording layer from the nonmagnetic material. Moreover, at this time, the mean grain size of the intermediate layer is preferably 2 nm or more and 14 nm or less. This is due to the size of the recording layer grains deposited over the intermediate layer being controlled and it is considered that it produces media noise when the grain size is less than 2 nm or greater than 14 nm. Therefore, the mean grain size of the intermediate layer grains is equal to or greater than the mean grain size of the recording layer grains. Moreover, the total film thickness of the intermediate layer is preferably 2 nm or more and 20 nm or less. If it is 2 nm or less, the isolation of the magnetic recording layer grains formed thereon is insufficient and, if it is 20 nm or more, the distance between the magnetic head and the soft magnetic under layer becomes too large and the recording resolution is decreased.

The magnetic recording layer has magnetic crystal grains which have a nearly columnar structure and large magnetic anisotropy and consists of one having a granular structure where the grain boundaries of the crystal grains are filled with nonmagnetic materials and the easy magnetization direction is perpendicular to the film surface. The magnetic crystal grains are composed of a CoCrPt alloy having an hcp structure and one where at least one element selected from Si, Ti, B, Ru, Ta, and Cu, etc. is added thereto. The magnetic crystal grains have nearly an epitaxial relationship with the seed layer crystal grains and the crystalline orientation is [001]. The average of crystal grain size of the magnetic crystal grains is preferably 2 nm or more and 12 nm or less. If it is smaller than 2 nm, the thermal stability decreases and a decay of the recording magnetization becomes noticeable. On the other hand, if it is larger than 12 nm, it is not preferable because of serious media noise. An oxide or a nitride of Si, Ti, Ta, Al, Mg, Cr, and Zr, etc. is used for the grain boundary of the magnetic crystal grain. A material for forming these magnetic crystal grains and a material for forming a nonmagnetic material which is the grain boundary thereof are simultaneously sputtered by using, for instance, magnetron sputter deposition equipment, resulting in the magnetic recording layer having a granular structure being formed. At this time, the grain size can be controlled by controlling sputter Ar gas pressure, the oxygen content in the Ar gas, and input electric power, etc. As film-deposition equipment herein, for instance, both film-deposition equipment where sputtering is alternately performed while a sputter target of a CoCrPt alloy and a sputter target of Si oxide are rotated and film-deposition equipment where sputtering is performed simultaneously using a mixed sputter target of a CoCrPt alloy and Si oxide can be used. Moreover, when the magnetic recording layer is deposited, a negative bias voltage from −150 V to −300 V may be applied. If it is a negative bias voltage having an absolute value smaller than 150 V, the crystalline orientation control of the magnetic crystal grains is insufficient and if it is a negative bias voltage having an absolute value larger than 300 V, controllability of the crystalline orientation is saturated.

The magnetic recording crystal grain size may be equal to or smaller than the crystal grain size of the nonmagnetic intermediate layer which is the seed layer thereof. This is due to it being necessary that the crystalline orientation of the magnetic crystal grains be controlled grain by grain. If the crystal grain size of the magnetic recording layer becomes larger than the crystal grain size of the nonmagnetic intermediate layer, the crystalline orientation is disordered in the grain and the media noise cannot be controlled. The volume fraction of the nonmagnetic material, for instance, Si oxide included in the magnetic recording layer, is preferably 10% or more and 30% or less. If the volume fraction of the nonmagnetic material is 10% or less, the grain boundary width which is formed surrounding the magnetic recording layer is not adequate and the effects of intergrain interaction becomes stronger, resulting in the media noise not being controlled. If the volume fraction of the nonmagnetic material is 30% or more, the coercivity is deteriorated. The coercivity of the magnetic recording layer measured in a direction perpendicular to the substrate may be 400 kA/m or more. The time decay of the recording magnetization becomes large when it is 400 kA/m or less. The film thickness of the magnetic recording layer may be 5 nm or more and 25 nm or less. This is due to, deterioration of the coercivity and deterioration of the thermal stability becomes noticeable when it becomes thinner than 5 nm. Moreover, if it is thicker than 25 nm, the distance between the magnetic head and the soft magnetic under layer becomes greater and the head magnetic field gradient becomes smaller, resulting in the recording resolution being deteriorated, and the head magnetic field strength becomes smaller, resulting in the overwrite property being deteriorated. Moreover, the recording layer may be composed of plural layers using a CoCrPt system alloy, etc.

A film containing carbon as a main component can be used for the protective layer. In addition, if the hardness is high and corrosion, etc. of the magnetic recording layer can be protected, it can be used in the same way. The film thickness of the protective layer is preferably 1 nm or more and 5 nm or less. If it is 1 nm or less, the protection is not sufficient when the head crashes into the medium surface and, if it is 5 nm or more, the distance between the magnetic head and the medium becomes greater, resulting in the recording resolution being deteriorated.

A fluorine system polymer oil such as perfluoroalkyl polyether can be used for a lubricant layer.

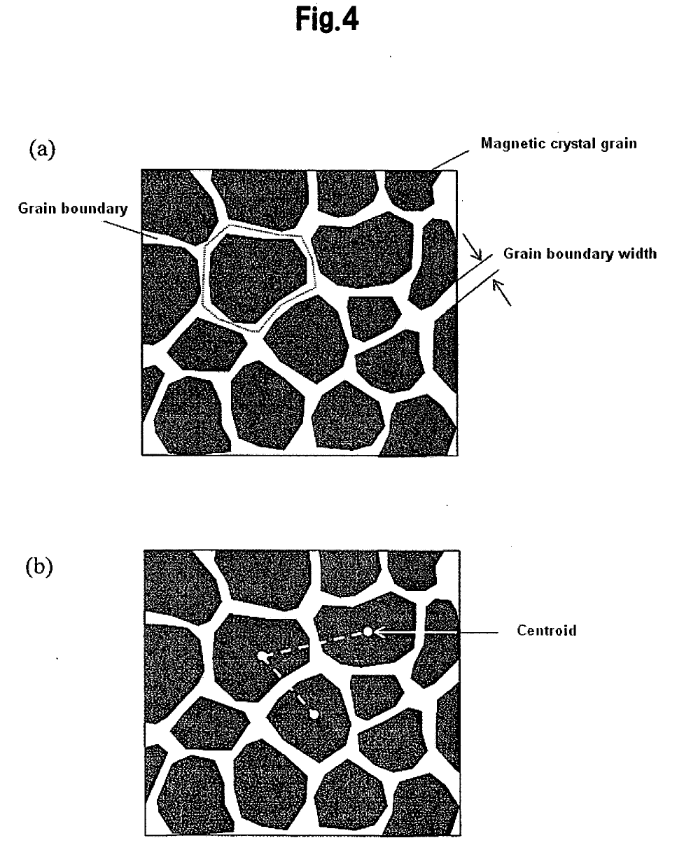

Next, an embodiment of a measurement method of the crystal grain size of the magnetic recording layer is described. Measurement of the crystal grain size is carried out by observation using a transmission electron microscope (TEM) and image analysis using commercially available particle analysis software. At first, a sample of the perpendicular magnetic recording media is made by chopping it into 2 mm squares using a disk cutter. The small pieces thus obtained are polished by using a grinder and thin films are made where a part thereof becomes only the recording layer and the protective layer. This thin film piece is observed by using a transmission electron microscope and a high-resolution bright-field image is taken. The bright field image is an image which is formed by blocking the diffracted electron beam using an objective aperture of the electron microscope and by using only the electron beam which is not diffracted. For instance, in the bright field image of the magnetic recording layer having a granular structure, the crystal grain part has dark contrast because of strong diffraction intensity and the grain boundary part is observed as a part with bright contrast because of the weak diffraction intensity. As shown in the dotted line in FIG. 4(a), lines are drawn at the center of the grain boundaries by using the particle analysis software, that is, the center of the bright contrast parts, and the area of the region including the grain and the grain boundary is measured as the pixel number. The obtained data are converted to the actual scale to obtain the area; the diameter of a circle having an area equal to this area is calculated; and the obtained value is assumed to be the grain size. 200 or more grains are measured to obtain the average of crystal grain size.

Moreover, in addition to the aforementioned measurement technique, a similar value can be obtained when the average of crystal grain size is calculated by grain-by-grain measurement of the centroid line of the neighboring grains. The technique is described as follows. In the bright field image of the magnetic recording layer having a granular structure, the crystal grain part is observed as a dark contrast part because of strong diffraction intensity and the grain boundary part is observed as a bright contrast part because of weak diffraction intensity. As shown in FIG. 4(b), the centroid is specified from the area of each magnetic recording grain using the particle analysis software and all of the centroid lines of the neighboring grains (the length shown in the dotted line) are measured. Herein the neighboring grains mean the grains where the other grain does not exist on the line drawn between the centers of gravity of two grains. A plurality of neighboring grains exists for one grain. All of the centroid lines are arithmetically averaged for neighboring particles. This measurement is performed on 200 or more particles, and the mean grain size is obtained by arithmetically averaging each obtained grain size.

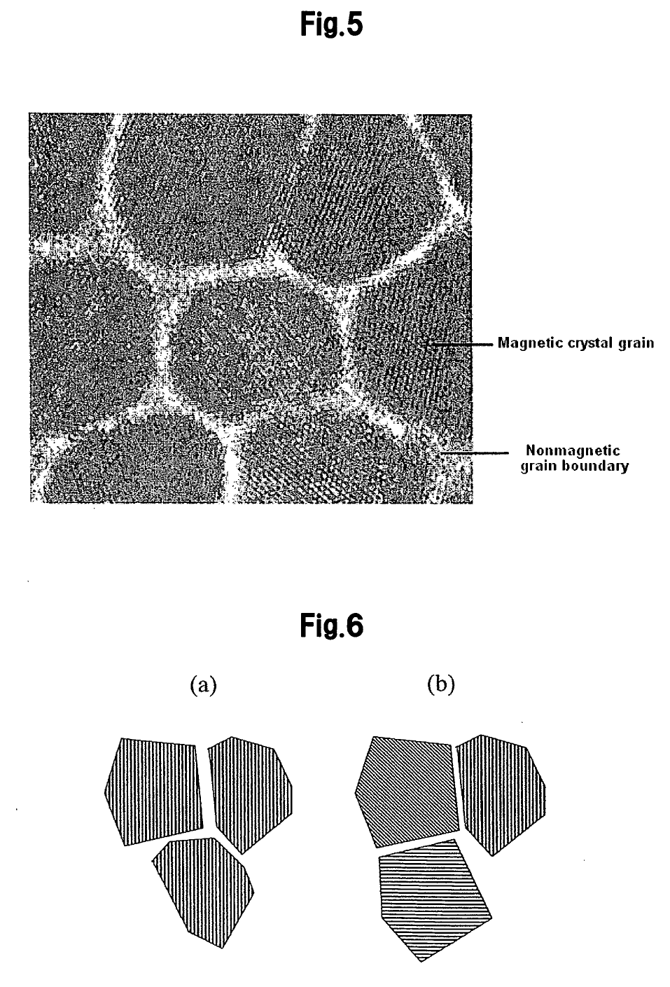

Next, an embodiment of a method for crystal orientation analysis of the magnetic recording layer is described. In the crystal orientation analysis, using observations made with a transmission electron microscope and commercially available particle analysis software, the image is analyzed. At first, the sample of the perpendicular magnetic recording media is made by chopping it into 2 mm squares using a disk cutter. The small pieces thus obtained are polished by using a grinder and polished more by thinning equipment using Ar gas, resulting in thin films being made where a part thereof becomes only the recording layer and the protective layer. This thin film piece is observed by using a transmission electron microscope and a crystal lattice image is taken. Herein, the crystal lattice image is an image obtained by the interference of the diffracted electron beam and the electron beam which is not diffracted in the transmission electron microscope observation. It is an image where a striped pattern corresponding to the crystal lattice plane is observed in the crystal grain and it is shown in FIG. 5. The direction and distance of this striped pattern are consistent with the direction and distance of the crystal face in a direction perpendicular to the substrate.

When a nearly hexagonal columnar CoCrPt alloy having an hcp structure is used for the magnetic recording layer, the c-axis is grown in a direction perpendicular to the film surface, so that lattice plane of the a-plane can be observed directly in the lattice image. Therefore, by analyzing the direction where the a-planes are aligned, that is, a-axis orientation, the a-axis orientation can be specified. The striped pattern schematically shown in FIG. 6 indicates the a-axis lattice plane and the orientation orthogonal to this lattice plane is the a-axis orientation. Moreover, for grains in which an a-plane is hardly observed, a-axis orientation analysis is carried out by FFT analysis using image software. The a-axis orientation is studied for 200 or more grains. The obtained a-axis orientations of neighboring grains are compared to each other and the relative angles are measured. As shown in FIG. 6(a), when the angle which forms a-axis crystal orientations of two or more neighboring grains is equal to or greater than 0 degrees and less than 1 degree, these grains are combined together and are defined to have the same crystal grain cluster. On the other hand, as shown in FIG. 6(b), when the crystal orientation of the a-axis of each grain has a different orientation, it is defined that a crystal grain cluster is not formed. All of the grain areas comprising the analyzed crystal grain cluster are summed up to be the area of the crystal grain cluster; the area of each crystal grain cluster is obtained; and the mean value is calculated. The obtained mean value of the crystal grain cluster area is divided by the mean value of the magnetic crystal grain area, and the value is defined as the normalization crystal grain cluster size Dn.

$$Dn = \frac{Crystal grain cluster size}{Average of crystal grain area} \qquad [ Expression 1 ]$$

Hereafter, embodiments of the present invention are described on the basis of the embodiments.

The first perpendicular magnetic recording media was manufactured as follows. A 30 nm thick Ni-37.5 at. % Ta-10 at. % Zr film was deposited over a cleaned tempered glass substrate by using a DC sputtering system in order to improve the adhesion with the substrate. Next, a 100 nm thick Fe-34 at. % Co-10 at. % Ta-5 at. % Zr film was deposited, resulting in the soft magnetic under layer being formed. Ar was used for the sputtering gas and the film was deposited under a total gas pressure of 0.7 Pa. Next, a 2 nm thick Ni-37.5 at % Ta film was formed as the first seed layer, an oxidation treatment was performed on the surface thereof, and a nucleus for controlling the grain size of the intermediate layer grain was formed. Thereon, a 7 nm thick second seed layer, a Ni-6 at. % W layer, was deposited. Ar was used for the sputtering gas and the film was deposited under a total gas pressure of 0.7 Pa. Next, a Ru film was deposited divided into two layers by using DC magnetron sputtering. The substrate temperature was room temperature; a 9 nm thick lower layer was formed at a deposition rate of 2 nm/s; Ar was used for the sputtering gas; and the total gas pressure was controlled to be 0.7 Pa. An 8 nm thick upper layer was formed at a deposition rate of 1 nm/s; Ar was used for the sputtering gas; and the total gas pressure was controlled to be 5 Pa.

Next, the lower magnetic recording layer was formed where the volume fraction of Co-17 at. % Cr-18 at. % Pt and SiO₂ was controlled to be 80:20. The Co-17 at. % Cr-18 at. % Pt and SiO₂ were deposited by simultaneous discharge using a DC magnetron sputtering technique and an RF magnetron sputtering technique, respectively. The film was deposited by sputtering under the conditions where Ar was used as the sputtering gas and the pressure was controlled to be 4.0 Pa. The film thickness was controlled to be 13.5 nm. A negative bias voltage (−200 V) was applied during the deposition. The sputtering targets of CoCrPt and Ru are mounted on the rotating holder and sputtering is performed when the target arrived over the disk substrate. The substrate temperature was room temperature. After that, as the upper magnetic recording layer, a 5.5 nm thick Co-12 at. % Cr-14 at. % Pt-10 at. % B film was formed to be the magnetic recording layer. At this time, the Ar sputtering gas pressure and the oxygen content in the sputtering gas were controlled to be 4.0 Pa and 0.5%, respectively. 5 nm thick carbon was formed thereon as a protection film.

The second perpendicular magnetic recording media was formed as follows. The same conditions as the first perpendicular magnetic recording media were used for forming up to the soft magnetic under layer; a 2 nm thick Ni-37.5 at. % Ta film was formed as the first seed layer and an oxidation treatment was performed on the surface. A 1 nm thick second seed layer Ni-6 at. % W layer was formed thereon and the nucleus for controlling the grain size of the intermediate layer grains was formed. After that, as the third seed layer, a seed layer was formed where the volume fraction of Co-6 at. % W and SiO₂ was controlled to be 95:5. The film thickness was controlled to be 6 nm. Next, a Ru film was deposited by using a DC magnetron sputtering technique with the substrate temperature at room temperature. A 7 nm thick lower layer was formed at a deposition rate of 2 nm/s; Ar was used for the sputtering gas; and the total gas pressure was controlled to be 0.7 Pa. A 7 nm thick upper layer was formed at a deposition rate of 1 nm/s; Ar was used for the sputtering gas; and the total gas pressure was controlled to be 5 Pa.

Next, the lower magnetic recording layer was formed where the volume fraction of Co-17 at. % Cr-18 at. % Pt and SiO₂ was controlled to be 80:20. The Co-17 at. % Cr-18 at. % Pt and SiO₂ were deposited by simultaneous discharge using a DC magnetron sputtering technique and an RF magnetron sputtering technique, respectively. The film was deposited by sputtering under the conditions where Ar was used as the sputtering gas and the pressure was 4.0 Pa. The film thickness was controlled to be 15 nm. A negative bias voltage (−200 V) was applied during the deposition. The sputtering targets of CoCrPt and Ru are mounted on the rotating holder and sputtering is performed when the target arrived over the disk substrate. The substrate temperature was room temperature. After that, as the upper magnetic recording layer, a 4 nm thick Co-23 at. % Cr-10 at. % Pt film was formed to be the magnetic recording layer. At this time, the Ar sputtering gas pressure and the oxygen content in the sputtering gas were controlled to be 4.0 Pa and 0.5%, respectively. 5 nm thick carbon was formed thereon as a protection film.

The third perpendicular magnetic recording media was formed as follows. The same conditions as the first perpendicular magnetic recording media were used for forming up to the soft magnetic under layer; a 3 nm thick Cr-50 at. % Ti film was formed as the first seed layer and a nucleus for controlling the grain size of the intermediate layer grains was formed by performing an oxidation treatment on the surface. A 1 nm thick second seed layer, Ni-6 at. % W layer, was formed thereon and, as the third seed layer, a seed layer was formed where the volume fraction of Ni-6 at. % W and SiO₂ was controlled to be 95:5. The film thickness was controlled to be 6 nm. Ar was used for the sputtering gas and the total gas pressure was controlled to be 0.7 Pa. Films above the Ru film were formed under the same conditions as the second magnetic recording medium.

The fourth magnetic recording medium was formed as follows. The same conditions as the first magnetic recording medium were used for forming up to the soft magnetic under layer; a 3 nm thick Ti film was formed as the first seed layer; a 3 nm thick Cr-50 at. % Ti film was formed as the second seed layer; and an oxidation treatment was performed on the surface. As the third seed layer, a seed layer was formed where the volume fraction of Ni-6 at. % W and SiO₂ was controlled to be 95:5. The film thickness was controlled to be 3 nm. Ar was used for the sputtering gas and the total gas pressure was controlled to be 0.7 Pa. Next, a Ru film was deposited by using a DC magnetron sputtering technique with the substrate temperature at room temperature. A 7 nm thick lower layer was formed at a deposition rate of 2 nm/s; Ar was used for the sputtering gas; and the total gas pressure was controlled to be 0.7 Pa. A 7 nm thick upper layer was formed at a deposition rate of 1 nm/s by using a Ru-10 at. % Ti alloy; a mixed gas of Ar and oxygen was used for the sputtering gas; and the deposition was performed under a total gas pressure of 6.5 Pa and an oxygen content of 1%. After that, deposition was performed under the same conditions as the first magnetic recording layer and, as the upper magnetic recording layer, a 4 nm thick Co-23 at. % Cr-10 at. % Pt film was formed. At this time, the Ar sputter gas pressure was 4.0 Pa and the oxygen content contained in the sputtering gas was 0.5%. 5 nm thick carbon was formed thereon as a protection film.

As a medium of a comparative example, the fifth magnetic recording medium was formed as follows. A 10 nm thick Ni-37.5 at. % Ta film was formed over an alkaline cleaned crystallized glass at room temperature. Next, the soft magnetic under layer was formed by depositing a 100 nm thick Co-10 at. % Ta-5 at. % Zr film; a 10 nm thick Ti film was deposited for the first seed layer; and a 1 nm thick second seed layer Cu layer was deposited. After that, as the third seed layer, an 8 nm thick Ni-6 at. % W layer was formed. The intermediate layer was deposited to be the same configuration as the fourth medium in the embodiment. The recording layer was made to be a two-layer configuration, and the magnetic recording layer was formed by depositing a 14 nm thick lower layer where the volume fraction of Co-17 at. % Cr-18 at. % Pt and SiO₂ was controlled to be 80:20 and a 4 nm thick Co-23 at. % Cr-10 at. % Pt film was formed as the upper layer. At this time, the Ar sputtering gas pressure was 4.0 Pa and the oxygen content contained in the sputtering gas was 0.5%. Moreover, a negative bias voltage of −200 V was applied during sputtering the lower recording layer. 5 nm thick carbon was formed thereon as a protection film.

As the sixth magnetic recording medium of the comparative example, the same conditions as the fifth magnetic recording medium of the comparative example were used in addition to form the third seed layer using an 8 nm thick Ni-8 at. % Fe film.

In the first to fourth magnetic recording media of the embodiments and the fifth and sixth magnetic recording media, the mean grain size and the normalization crystal grain cluster size were measured by using detailed analyses of the plane bright field image and the lattice image of the granular film (magnetic recording layer) including CoCrPt and SiO₂, which were observed by a transmission electron microscope, resulting in the normalization crystal grain cluster size being obtained. As a result, in the first magnetic recording medium, the mean grain size of the magnetic recording layer was 7.7 nm and the normalization crystal grain cluster size was 1.2. In the second magnetic recording medium, the mean grain size of the magnetic recording layer was 7.7 nm and the normalization crystal grain cluster size was 1.4. At this time, both mean grain sizes of the nonmagnetic intermediate layers of the first and second magnetic recording medium were 10.0 nm. When the third magnetic recording medium was similarly measured, the mean grain size of the magnetic recording layer was 7.6 nm and the normalization crystal grain cluster size was 1.7. At this time, the mean grain size of the nonmagnetic intermediate layer was 10.0 nm. When the fourth magnetic recording medium was similarly measured, the mean grain size of the magnetic recording layer was 7.6 nm and the normalization crystal grain cluster size was 1.9. At this time, the mean grain size of the nonmagnetic intermediate layer was 10.1 nm.

In the first to fourth magnetic recording medium, there is less difference in the mean grain sizes of the magnetic crystal grains, but the normalization crystal grain cluster sizes thereof were greatly changed. Moreover, when the cross-sectional surfaces of these media were observed by using a transmission electron microscope, it was understood from the bright field images and the diffraction images that, in any of the media, the nearly columnar structured crystal grains constituting the magnetic layer and the crystal grains constituting the nonmagnetic intermediate layer had an hexagonal closed packed structure (hcp) and that they contacted to each other. At this time, it was understood that the magnetic layer crystal grain size was equal to or smaller than the size of the nonmagnetic intermediate layer crystal grains in the crystal grains of the magnetic layer and the nonmagnetic intermediate layer.

In the fifth magnetic recording medium of the comparative example, the mean grain size of the magnetic recording layer was 8.5 nm, the normalization crystal grain cluster size was 2.0. And, at this time, the mean grain size of the nonmagnetic intermediate layer was 11.5 nm. In the sixth magnetic recording medium of the comparative example, the mean grain size of the magnetic recording layer was 7.1 nm, and the normalization crystal grain cluster size was 2.7. Although they are not so much different from the mean grain sizes of the four kinds of media in the embodiment, the normalization crystal grain cluster sizes thereof were greatly changed. Moreover, when the cross-sectional surfaces of the fifth and sixth media were observed by using a transmission electron microscope, it was understood from the bright field images and the diffraction images that, in any of the media, the nearly columnar structured crystal grains constituting the magnetic layer and the crystal grains constituting the nonmagnetic intermediate layer had an hexagonal closed packed structure (hcp) and that they contacted to each other. At this time, it was understood that the magnetic layer crystal grain size was equal to or smaller than the size of the nonmagnetic intermediate layer crystal grains in the crystal grains of the magnetic layer and the nonmagnetic intermediate layer.

Next, an organic lubricant layer was coated over the magnetic recording media in the first to fourth embodiments and fifth and sixth in the comparative example, and an evaluation of the write/read characteristics and an evaluation of the recording density were carried out by using spin stand equipment using a magnetic head where a single pole having the recording track width of 200 nm and a tunnel magnetoresistance effect element having a read track width of 140 nm were provided.

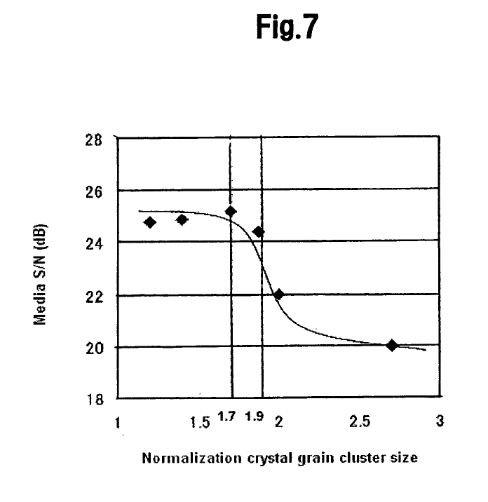

As a result, as shown in FIG. 7, although an media S/N of 24.8 dB was obtained in the first magnetic recording medium, 24.9 dB in the second magnetic recording medium, and 25.2 dB in the third magnetic recording medium, 23.6 dB was obtained in the fourth magnetic recording medium, in which a decrease of about 1.6 dB was observed. Moreover, 22.1 dB was obtained in the fifth magnetic recording medium of the comparative example and 20.3 dB was obtained in sixth magnetic recording medium of the comparative example, in which a decrease of about 5 dB was obtained compared with the medium in the embodiment. The value of the normalization crystal grain cluster size is increased, that is, the region having the same crystal orientation is increased, thereby the intergrain interaction in the cluster worked strongly. As a result, the media noise was increased and a decrease in the media S/N was induced. Specifically, it is understood that it was necessary to not only decrease the mean grain size of the recording layer grain size but also to control the crystal grain orientation to be different grain-by-grain. In order to make it, it became clear that the range of the normalization crystal grain cluster size Dn was 1 or more and 1.9 or less. Moreover, a particularly desirable range of the normalization crystal grain cluster size Dn was 1.7 or less.

Moreover, it became clear that deterioration of the media S/N can be prevented if the perpendicular recording medium was in this range.

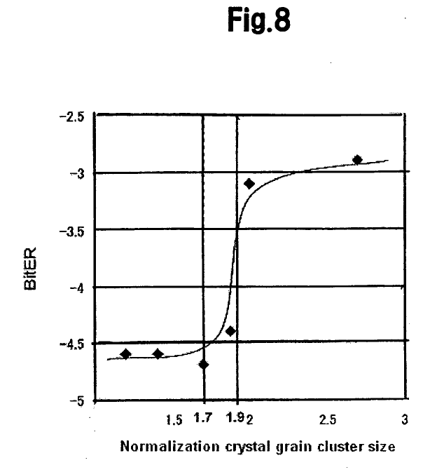

Moreover, BitER (BitER: (number of bit errors)/(number of read bits) when 108 bits of data are read) was measured with a linear recording density of 1 MBPI by using a magnetic head which includes a single pole type head having a 100 nm write track width and a tunnel magnetoresistance effect element having an 80 nm read track width. As a result, as shown in FIG. 8, 10^{-4.6}, 10^{-4.7}, and 10^{-4.4} were obtained from the first and second magnetic recording media, the third magnetic recording medium, and the fourth magnetic recording medium of the embodiment, respectively. 10^{-3.1} was obtained from the fifth magnetic recording medium of the comparative example where the value of the normalization crystal grain cluster size was large and 10^{-2.9} was obtained from the sixth magnetic recording medium of the comparative example. It is understood that the BitER value becomes worse drastically when the value of the normalized crystal cluster becomes greater than 1.9. Thus, from the viewpoint of the bit error rate during reading, it is necessary that the region of the normalization crystal grain cluster size Dn be 1.9 or less and preferably 1.7 or less.

As clearly understood from the above-mentioned explanation, it is thought that the crystal grain cluster influences not only the microstructure but also the magnetic characteristics. Accordingly, a medium having a high S/N and an improved BitER can be obtained by controlling the formation of the crystal grain cluster and controlling the normalization crystal grain cluster size, and it is necessary that the region of the normalization crystal grain cluster size be 1 or more and 1.9 or less. Moreover, it is more preferable that the normalization crystal grain cluster size be 1.7 or less.

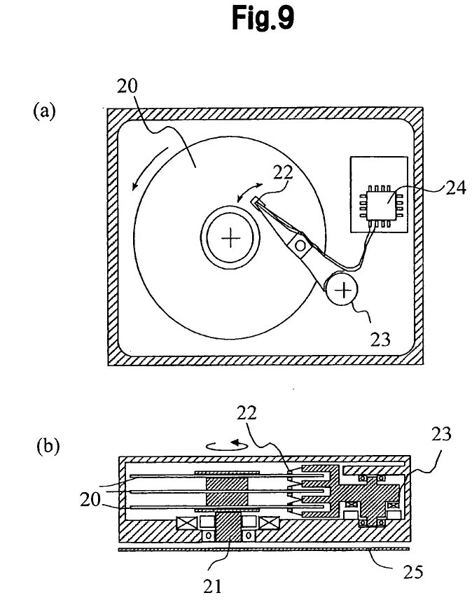

FIG. 9 is a schematic drawing illustrating a magnetic recording system. FIG. 9(a) is a plane schematic drawing and FIG. 9(b) is a cross-sectional schematic drawing. The magnetic recording media 20 is composed of a perpendicular magnetic recording medium according to the aforementioned embodiments 1 to 4, and the magnetic recording system includes a spindle motor 21 which drives this magnetic recording medium, a magnetic head 22 which has a write part and a read part, an actuator 23 which brings the magnetic head into motion relative to the magnetic recording medium, a signal processing IC 24 for input/output of the signal to the magnetic head, and an IC package board 25 for performing signal control. A large capacity magnetic recording system can be obtained by using a medium of the present invention. For instance, the first areal density of the embodiment was measured as 299 Gb/in², the second magnetic recording medium 260 Gb/in², the third magnetic recording medium 285 Gb/in², the fourth magnetic recording medium 270 Gb/in², and the fifth magnetic recording medium 220 Gb/in², that is, all media of the embodiments 1 to 4 satisfied 250 Gb/in or more.

As explained above, formation of the crystal grain cluster was controlled by appropriately controlling not only the crystal grain size of the seed layer grains but also the relationship with the crystal orientation of the seed layer and the lattice constant of the intermediate layer, so that perpendicular magnetic recording media having a high media S/N could be obtained where the normalization crystal grain cluster size Dn is 1≦Dn≦1.9 and the exchange coupling between the magnetic crystal grains being controlled. In order to have a high media S/N, it was found that it was necessary to satisfy the region of 1≦Dn≦1.7.

Moreover, the constituent elements and composition of each layer used in the aforementioned embodiment may be changed, for instance, the composition of the CoCrPt alloy of the recording layer can be changed in order to control the magnitude of the saturation magnetization and the coercivity. Even in this case, the relationship between the magnetic crystal grain size and the magnitudes of crystal grain sizes in the intermediate layer and seed layer, as well as the relationship with the value of the normalization crystal grain cluster size are similarly structured. Moreover, for instance, if one alters the type of substrate and the type and configuration of the soft magnetic under layer, there is little effect on the microstructures of the magnetic recording layer, the nonmagnetic intermediate layer, and the seed layer, and there is neither an effect on the mean grain size of the magnetic recording layer grains nor on the relationship between the crystalline orientation and the normalization crystal grain cluster size.

What is claimed is:

1. A perpendicular magnetic recording medium comprising:
a substrate; and
formed over the substrate, a soft magnetic under layer, a seed layer, a nonmagnetic intermediate layer comprising column structured crystal grains, and a magnetic recording layer having a structure, in which columnar structured magnetic crystal grains are partitioned by the grain boundaries,
wherein the magnetic crystal grains included in said magnetic recording layer have a normalization crystal grain cluster size Dn of 1 or more and 1.9 or less, which is obtained by dividing a mean value of the area of crystal grain cluster on the recording layer obtained by summation of the area of neighboring magnetic crystal grains having the same crystal orientation in both an a-axis and a c-axis by a mean value of said magnetic crystal grain areas.

2. The perpendicular magnetic recording medium according to claim 1, wherein said normalization crystal grain cluster size Dn is 1 or more and 1.7 or less.

3. The perpendicular magnetic recording medium according to claim 1, wherein an average of crystal grain size of said magnetic recording later is smaller than an average of crystal grain size of said nonmagnetic intermediate layer.

4. The perpendicular magnetic recording medium according to claim 1, wherein said magnetic crystal grains have an easy axis in a direction nearly perpendicular to the substrate surface.

5. The perpendicular magnetic recording medium according to claim 1, wherein said magnetic crystal grains and crystal grains comprising the nonmagnetic intermediate layer have a hexagonal closed packed structure (hcp) and are neighboring to each other.

6. The perpendicular magnetic recording medium according to claim 1, wherein said magnetic crystal grains comprise a CoCrPt alloy or an alloy containing CoCrPt as a main component.

7. The perpendicular magnetic recording medium according to claim 1, wherein crystal grains comprising said nonmagnetic intermediate layer comprise Ru or an alloy containing Ru as a main component.

8. The perpendicular magnetic recording media according to claim 1, wherein the areal density thereof is 250 Gb/in² or more.

9. A magnetic recording system comprising:
perpendicular magnetic recording medium;
a spindle motor which drives said perpendicular magnetic recording medium;
a magnetic head which performs write/read operations on said perpendicular magnetic recording medium; and
an actuator which positions said magnetic head to the desired position of said perpendicular magnetic recording medium,
wherein said perpendicular magnetic recording medium has a soft magnetic under layer, a seed layer, a nonmagnetic intermediate layer composed of crystal grains which have a columnar structure, and a magnetic recording layer having a structure, in which the columnar structured magnetic crystal grains are partitioned by grain boundaries, over a substrate, and
wherein the magnetic crystal grains included in said magnetic recording layer have a normalization crystal grain cluster size Dn of 1 or more and 1.9 or less which is obtained by dividing a mean value of the area of crystal grain cluster on the recording layer obtained by summation of the area of neighboring magnetic crystal grains having the same crystal orientation in both an a-axis and a c-axis by a mean value of said magnetic crystal grain areas.

10. The magnetic recording system according to claim 9, wherein said normalization crystal grain cluster size Dn is 1 or more and 1.7 or less.

11. The magnetic recording system according to claim 9, wherein an average of crystal grain size of said magnetic recording later is smaller than an average of crystal grain size of said nonmagnetic intermediate layer.

12. The magnetic recording system according to claim 9, wherein said magnetic crystal grains have an easy axis in a direction nearly perpendicular to the substrate surface.

13. The magnetic recording system according to claim 9, wherein said magnetic crystal grains and crystal grains comprising the nonmagnetic intermediate layer have a hexagonal closed packed structure (hcp) and are neighboring to each other.

14. The magnetic recording system according to claim 9, wherein said magnetic crystal grains comprise a CoCrPt alloy or an alloy containing CoCrPt as a main component.

15. The magnetic recording system according to claim 9, wherein crystal grains comprising said nonmagnetic intermediate layer comprise Ru or an alloy containing Ru as a main component.

16. The magnetic recording system according to claim 9, wherein the areal density thereof is 250 Gb/in² or more.
